(19) United States
(12) Patent Application Publication
(10) Pub. No.: US 2025/0187061 A1
(43) Pub. Date: Jun. 12, 2025

(54) HOLLOW MEMBER AND HOLLOW MEMBER MANUFACTURING METHOD

(71) Applicant: NIPPON STEEL CORPORATION, Tokyo (JP)

(72) Inventors: Nasa SHIMAZAKI, Tokyo (JP); Ryota MATSUBAYASHI, Tokyo (JP)

(73) Assignee: NIPPON STEEL CORPORATION, Tokyo (JP)

(21) Appl. No.: 18/842,324

(22) PCT Filed: Jun. 24, 2022
(86) PCT No.: PCT/JP2022/025223

§ 371 Date: Aug. 28, 2024

(51) Int. Cl. B21D 35/00; B21D 22/28; B21D 41/02

(52) U.S. Cl. CPC B21D 35/005; B21D 22/28; B21D 41/026

(57) ABSTRACT

The present hollow member has a circumferential hardness difference portion in at least a portion in a longitudinal direction along a central axis. When the circumferential hardness difference portion is viewed in a cross section orthogonal to the central axis, a wall thickness difference obtained by subtracting an absolute minimum value of the wall thickness from an absolute maximum value of the wall thickness in a circumferential direction of the cross section is 20% or less of an average value of the wall thickness in a whole circumference of the cross section. Furthermore, when an average of integration of Vickers hardness in the whole circumference of the cross section is used as a hardness threshold, the cross section includes a low strength range in which the Vickers hardness along the circumferential direction is equal to or less than the hardness threshold and a high strength range in which the Vickers hardness along the circumferential direction is more than the hardness threshold.

### TECHNICAL FIELD

The present disclosure relates to a hollow member and a hollow member manufacturing method.

### BACKGROUND ART

It is known that a vehicle body member (hollow member) constituting a vehicle body of an automobile is manufactured using a variable wall thickness steel pipe having different wall thicknesses along a longitudinal direction thereof. An example of a method for manufacturing this type of variable wall thickness steel pipe is disclosed in Patent Document 1. This Patent Document 1 discloses a method for manufacturing a variable wall thickness steel pipe from a hollow cylindrical raw pipe, the method including: a locking step of disposing the raw pipe in a die, and pushing a plug from one end side of the raw pipe to enlarge an outer shape of the raw pipe at the one end side to lock the plug to the die in a state where movement of the raw pipe in a longitudinal direction is restricted; and an ironing step of performing ironing to enlarge an inner shape of the raw pipe while maintaining an outer shape thereof to form a thin wall portion by further pushing the plug toward the other end side of the raw pipe while releasing the restriction of the raw pipe and maintaining the locking of the raw pipe.

### CITATION LIST

### Patent Document

Patent Document 1: PCT International Publication No. WO 2017/154481

### SUMMARY OF THE INVENTION

### Problems to be Solved by the Invention

On the other hand, in a collision safety performance test of an automobile, safety against collision is evaluated by a degree of deformation of a vehicle body member or the like. The vehicle body member preferably has high robustness of deformation against a collision condition. The robustness of deformation against a collision condition means that even when a collision condition such as a collision angle is slightly changed, a deformation mode of the vehicle body member is not changed, and stable deformation can be obtained.

As a conventional constitution for obtaining a stable deformation mode, for example, there is a constitution in which a loose bend is applied in advance to an intermediate position of a vehicle body member (hollow member) in a longitudinal direction. However, in this constitution, when an external force in a twisting direction is applied during normal operation that does not lead to a collision, there is a concern that the vehicle body member may behave unstably to deteriorate component performance.

The present disclosure has been made in view of the above circumstances, and an object of the present disclosure is to provide a hollow member having enhanced robustness without deteriorating component performance during normal operation, and a hollow member manufacturing method for manufacturing the hollow member.

### Means for Solving the Problem

The present disclosure has adopted the following aspects in view of the above circumstances.

That is,

(1) A hollow member according to one aspect of the present disclosure
has a circumferential hardness difference portion in at least a portion in a longitudinal direction along a central axis, in which
when the circumferential hardness difference portion is viewed in a cross section orthogonal to the central axis,
a wall thickness difference obtained by subtracting an absolute minimum value of the wall thickness from an absolute maximum value of the wall thickness in a circumferential direction of the cross section is 20% or less of an average value of the wall thickness in a whole circumference of the cross section, and
when an average of integration of Vickers hardness in the whole circumference of the cross section is used as a hardness threshold, the cross section includes a low strength range in which the Vickers hardness along the circumferential direction is equal to or less than the hardness threshold and a high strength range in which the Vickers hardness along the circumferential direction is more than the hardness threshold.

According to the aspect described in the above (1), by inclusion of the circumferential hardness difference portion, the low strength range that is relatively soft and the high strength range that is relatively hard in the circumferential direction are formed in the same cross section of the hollow member. During normal operation, both the low strength range and the high strength range support an external force within a range of elastic deformation, and therefore component performance is not deteriorated. On the other hand, when an external force such as an impact force stronger than that during normal operation is applied, the low strength range in the circumferential hardness difference portion is plastically deformed positively to absorb energy. As a result, the hollow member is bent and deformed such that the low strength range is on a recess side and the high strength range is on a protrusion side. As described above, a bending direction of the hollow member can be set by a relative positional relationship between the low strength range and the high strength range, and therefore the hollow member has high robustness.

(2) In the hollow member described in the above (1),
a ratio of a circumferential length of the low strength range to a whole outer circumferential length of the cross section may be within a range of 20% to 80%.

In the case of the above (2), since a lower limit of the ratio is 20%, the circumferential hardness difference portion can be plastically deformed and bent reliably in the low strength range. On the other hand, since an upper limit of the ratio is 80%, a bending direction of the hollow member can be limited within a predetermined range by limiting the low strength range so as not to be excessively wide.

(3) In the hollow member described in the above (1) or (2), the following constitution may be adopted:
a whole outer circumferential length in the cross section is Lr (mm); and
a hardness maximum position at which the Vickers hardness is an absolute maximum value is within a range of 0.3×Lr (mm) to 0.7×Lr (mm) in the circumferential direction with a hardness minimum position at which the Vickers hardness is an absolute minimum value as a reference.

In the case of the above (3), the portion where the Vickers hardness is the absolute minimum value and the portion where the Vickers hardness is the absolute maximum value can be formed substantially opposite to each other with the central axis of the hollow member interposed therebetween. Therefore, the bending direction of the hollow member is more easily controlled.

(4) In the hollow member according to any one of the above (1) to (3), the following constitution may be adopted:
the wall thickness difference in the cross section is 0.10 mm or less; and
a difference obtained by subtracting an absolute minimum value of the Vickers hardness from an absolute maximum value of the Vickers hardness in the cross section is HV or more.

In the case of the above (4), since the wall thickness along the circumferential direction in the cross section is made more uniform, and the difference in Vickers hardness is increased to 15 HV or more, the hollow member in the low strength range can be plastically deformed easily, and a bending direction of the hollow member can be set more accurately.

(5) In the hollow member according to any one of the above (1) to (4),
the circumferential hardness difference portion may be formed only in a part of the longitudinal direction.

In the case of the above (5), even when the difference in Vickers hardness between the high strength range and the low strength range is small, the hollow member can be bent by plastically deforming the hollow member in the low strength range reliably. As an example, in the form of FIG. 17(a) to be described later, the hollow member can be bent with a difference in Vickers hardness (for example, 10 HV) smaller than that in the form of FIG. 16(a).

(6) In the hollow member according to any one of the above (1) to (4),
the circumferential hardness difference portion may be formed over a total length in the longitudinal direction.

In the case of the above (6), an external force required to bend and deform the hollow member can be intentionally set to a higher value.

(7) A hollow member manufacturing method according to one aspect of the present disclosure is
a method for manufacturing a hollow member from a hollow cylindrical raw pipe, the method including:
a raw pipe disposition step of disposing the raw pipe in a die; and
an ironing step of ironing a material of an inner wall of the raw pipe so as to feed out the material in a circumferential direction of the inner wall when viewed from a line of sight along a central axis of the raw pipe while enlarging the inner wall by pushing a plug into the raw pipe.

According to the aspect described in the above (7), the material of the inner wall is fed out in the circumferential direction of the inner wall in the ironing step when viewed from the line of sight along the central axis of the raw pipe. As a result, on the inner wall after the ironing, a high strength range where the material concentrates and the Vickers hardness is increased and a low strength range where the material flows out and the Vickers hardness is relatively lowered are formed. According to the hollow member having the high strength range and the low strength range, during normal operation, both the low strength range and the high strength range support an external force within a range of elastic deformation, and therefore component performance is not deteriorated. On the other hand, when an external force such as an impact force stronger than that during normal operation is applied, the low strength range is plastically deformed positively to absorb energy. As a result, the hollow member is bent and deformed such that the low strength range is on a recess side and the high strength range is on a protrusion side. Therefore, a bending direction of the hollow member can be set according to a relative positional relationship between the low strength range and the high strength range, and therefore a hollow member having high robustness can be manufactured.

(8) In the hollow member manufacturing method described in the above (7), the following may be adopted:
the plug has a distal end portion tapered in a push-in direction and a main body portion continuous with a rear end of the distal end portion and having a maximum outer shape dimension in a cross section perpendicular to the push-in direction; and
a surface including a connection line between the distal end portion and the main body portion is inclined with respect to a surface orthogonal to a central axis of the plug.

In the case of the above (8), since the surface including the connection line between the distal end portion and the main body portion is inclined, a timing when the connection line irons the inner wall of the raw pipe in the push-in direction of the plug can vary depending on a position of the raw pipe in the circumferential direction along the inner wall. That is, among points on the connection line, a point on a distal end side in the push-in direction irons the inner wall earlier, and a point on a rear end side in the push-in direction irons the inner wall later. As a result, a previously ironed material moves along the circumferential direction and goes to a region to be ironed later. In this way, in the hollow member after the ironing, a high strength range where the material concentrates and the Vickers hardness is increased and a low strength range where the material flows out and the Vickers hardness is relatively lowered are formed.

(9) In the hollow member manufacturing method described in the above (7), the following may be adopted:
the plug has a distal end portion tapered in a push-in direction and a main body portion continuous with a rear end of the distal end portion and having a maximum outer shape dimension in a cross section perpendicular to the push-in direction; and
a connection line between the distal end portion and the main body portion includes:
a plurality of first connection points closest to a distal end surface of the plug in a side view; and
a plurality of second connection points located between the first connection points in a front view and located farther from the distal end surface than the first connection points in a side view.

In the case of the above (9), in the push-in direction of the plug, a timing when the first connection points iron the inner wall of the raw pipe can be made earlier than a timing when the second connection points pass the inner wall of the raw pipe. That is, among points on the connection line, the first connection points on a distal end side in the push-in direction iron the inner wall earlier, and the second connection points on a rear end side in the push-in direction iron the inner wall later. As a result, a previously ironed material moves along the circumferential direction and goes to a region to be ironed later. In this way, in the hollow member after the ironing, a high strength range where the material concentrates and the Vickers hardness is increased and a low strength range where the material flows out and the Vickers hardness is relatively lowered are formed.

(10) The hollow member manufacturing method according to any one of the above (7) to (9) may further include:
a locking step of locking an enlarged portion where an outer shape of an end portion of the raw pipe is enlarged in the die, by pushing the plug into the end portion after the raw pipe disposition step and before the ironing step; and
a drawing step of causing the enlarged portion to pass through another die to reduce the enlarged portion after the ironing step.

In the case of the above (10), it is possible to manufacture a hollow member having a circumferential hardness difference portion at an intermediate position in the longitudinal direction while having a uniform outer shape dimension along the longitudinal direction.

(11) The hollow member manufacturing method described in the above (10) may further include,
after the drawing step, a press working step of performing press forming such that a cross-sectional shape perpendicular to the central axis is rectangular.

In the case of the above (11), a hollow member having a rectangular outer shape can be manufactured.

(12) The hollow member manufacturing method described in any one of the above (7) to (9) may further include,
after the drawing step, a press working step of performing press forming such that a cross-sectional shape perpendicular to the central axis is rectangular.

In the case of the above (12), a hollow member having a rectangular outer shape can be manufactured.

### Effects of the Invention

According to the present disclosure, it is possible to provide a hollow member having enhanced robustness without deteriorating component performance during normal operation, and a hollow member manufacturing method for manufacturing the hollow member.

### BRIEF DESCRIPTION OF THE DRAWINGS

FIG. 1 is a side view of a hollow member according to an embodiment of the present disclosure, and indicates a Vickers hardness distribution in a circumferential direction by gradation.

FIG. 2 is a diagram showing a main part of the hollow member, in which (a) is an enlarged view of a portion A in FIG. 1, and (b) is a cross-sectional view taken along line B-B in (a). Note that the Vickers hardness distribution in the circumferential direction is indicated by gradation.

FIG. 3 is a graph showing an example of the Vickers hardness distribution of the hollow member, in which a horizontal axis indicates a measurement position in the circumferential direction, and a vertical axis indicates Vickers hardness at each position.

FIG. 4 is a side view showing a case where a load is applied to the hollow member, in which (a) shows a state before the load is applied, and (b) shows a state after the load is applied. Note that the Vickers hardness distribution in the circumferential direction is indicated by gradation.

FIG. 5 is a diagram showing a head portion of a plug used in a hollow member manufacturing method of the embodiment, in which (a) is a perspective view viewed from a distal end side thereof, and (b) is a perspective view viewed from a rear end side thereof.

FIG. 6 is a diagram showing the head portion, in which (a) is a side view, and (b) is a front view.

FIG. 7 is a cross-sectional view showing a first half of the hollow member manufacturing method using a plug having the head portion in chronological order of (a) to (c). Here, (a) shows a raw pipe disposition step, (b) shows a locking step, and (c) shows an ironing step.

FIG. 8 is a cross-sectional view showing a latter half of the hollow member manufacturing method following FIG. 7(c) in chronological order of (a) and (b). Here, (a) shows a start time of a drawing step, and (b) shows a completion time thereof.

FIG. 9 is a diagram for explaining a modification example of the hollow member, and is a graph showing a Vickers hardness distribution of the hollow member. Here, a horizontal axis indicates a measurement position in the circumferential direction, and a vertical axis indicates Vickers hardness at each position.

FIG. 10 is a side view showing another modification example of the hollow member, in which (a) shows a case where a circumferential distribution of Vickers hardness is imparted over the total length, and (b) shows a case where a circumferential distribution of Vickers hardness is imparted to a half in a longitudinal direction. Note that the Vickers hardness distribution in the circumferential direction is indicated by gradation.

FIG. 11 is a diagram showing another modification example of the hollow member, and is a graph showing a Vickers hardness distribution of the hollow member. A horizontal axis indicates a measurement position in the circumferential direction, and a vertical axis indicates Vickers hardness at each position.

FIG. 12 is a front view of a plug used for manufacturing the hollow member of FIG. 11.

FIG. 13 is a side view showing First Example of the present disclosure, in which hollow members T2, T4, and T5 are Examples, and hollow members T1 and T3 are Comparative Examples. Note that the Vickers hardness distribution in the circumferential direction is indicated by gradation.

FIG. 14 is a side view showing a test condition when an external force is applied to the hollow members T1 to T5, in which (a) shows Model A in which the hollow members T1 to T5 are supported on a surface orthogonal to a central axis CL thereof, and (b) shows Model B in which the hollow members T1 to T5 are supported on a surface forming an inclination angle of 15 degrees with respect to a central axis CL thereof.

FIG. 15 is a diagram showing Second Example of the present disclosure, and is a graph showing a Vickers hardness distribution in a circumferential direction of a hollow member obtained by the hollow member manufacturing method using a plug having the head portion shown in FIG. 6. Here, a horizontal axis indicates a measurement position in the circumferential direction, and a vertical axis indicates Vickers hardness at each position.

FIG. 16 is a diagram showing Third Example of the present disclosure, and is a side view in a case where a Vickers hardness distribution is formed over the total length. Here, (a) shows a state before an impact force is applied, and (b) and (c) show a state after the impact force is applied. (b) shows a case where a difference in Vickers hardness between a strong portion and a weak portion is 15 HV, and (c) shows a case where the difference in Vickers hardness between the strong portion and the portion part is 10 HV. Note that the Vickers hardness distribution in the circumferential direction is indicated by gradation.

FIG. 17 is a diagram showing Fourth Example of the present disclosure, and is a side view in a case where a Vickers hardness distribution is formed at a central position in the longitudinal direction. Here, (a) shows a state before an impact force is applied, and (b) and (c) show a state after the impact force is applied. (b) shows a case where a difference in Vickers hardness between a strong portion and a weak portion is 10 HV, and (c) shows a case where the difference in Vickers hardness between the strong portion and the portion part is 5 HV. Note that the Vickers hardness distribution in the circumferential direction is indicated by gradation.

### EMBODIMENT FOR IMPLEMENTING THE INVENTION

An embodiment and modification examples of a hollow member and a hollow member manufacturing method according to the present disclosure will be described below with reference to the drawings. Note that, in the drawings, the size and shape of each portion may be appropriately exaggerated in order to facilitate understanding. In the drawings, hatching or reference numbers may be omitted for convenience. Furthermore, a direction along a central axis of the hollow member may be referred to as a longitudinal direction, and a direction along a circumference of an inner wall surface or an outer wall surface of the hollow member with the central axis as a center may be referred to as a circumferential direction. Unless otherwise specified, such as “an average value of an absolute maximum value and an absolute minimum value”, each average value regarding Vickers hardness indicates an average of integration in a circumferential direction of a cross section.

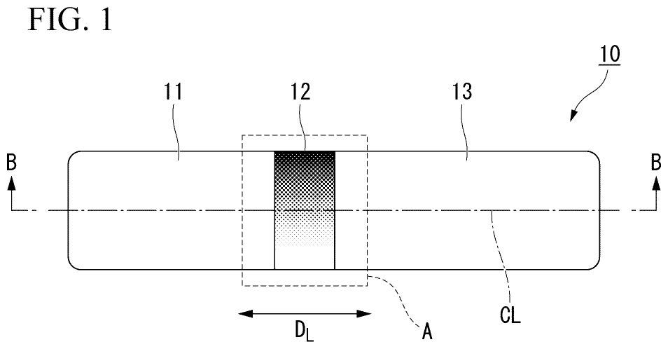

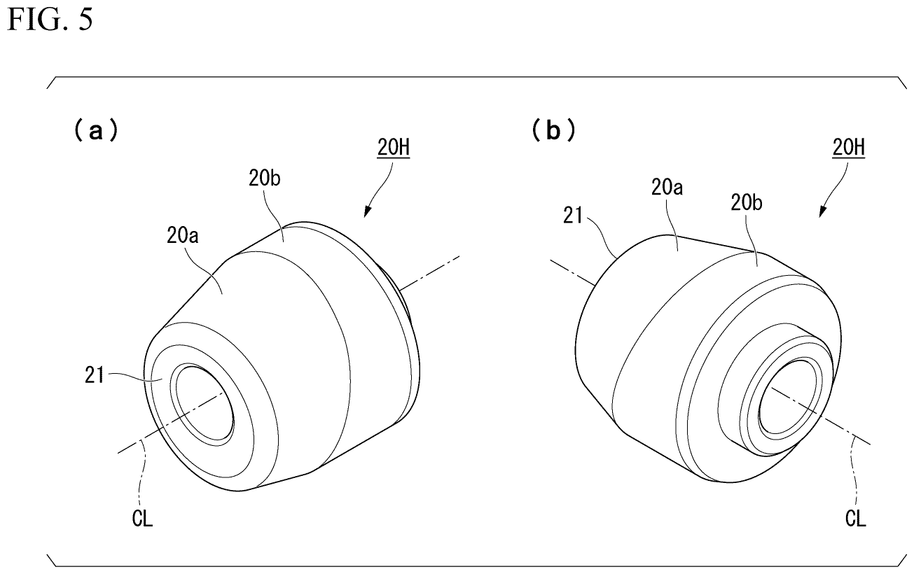

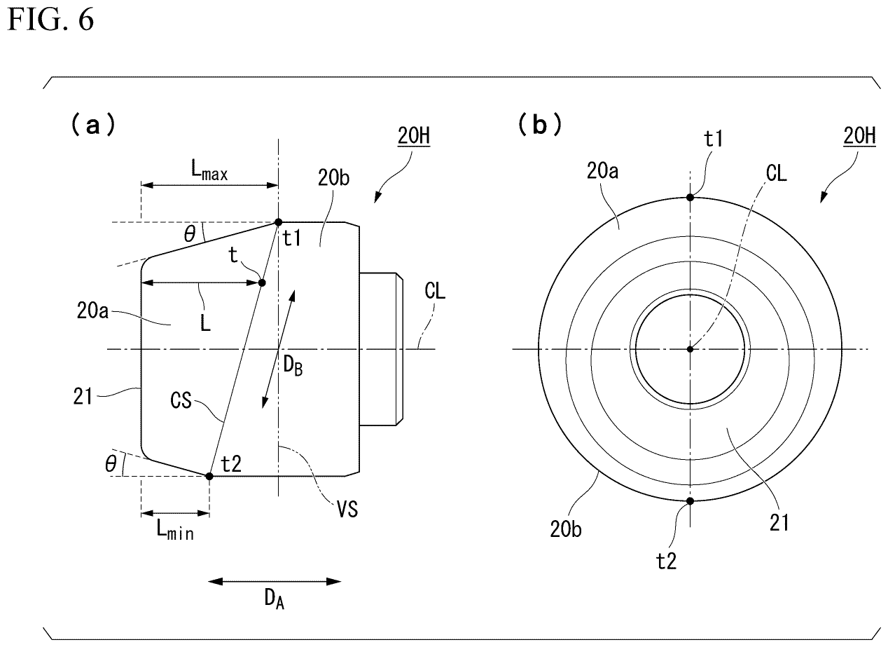

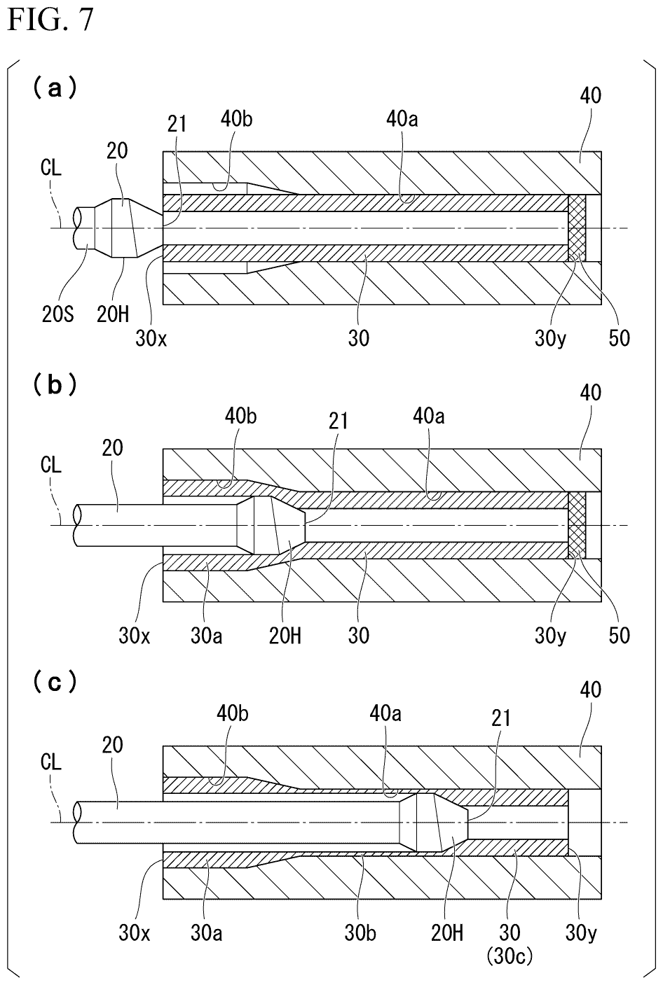

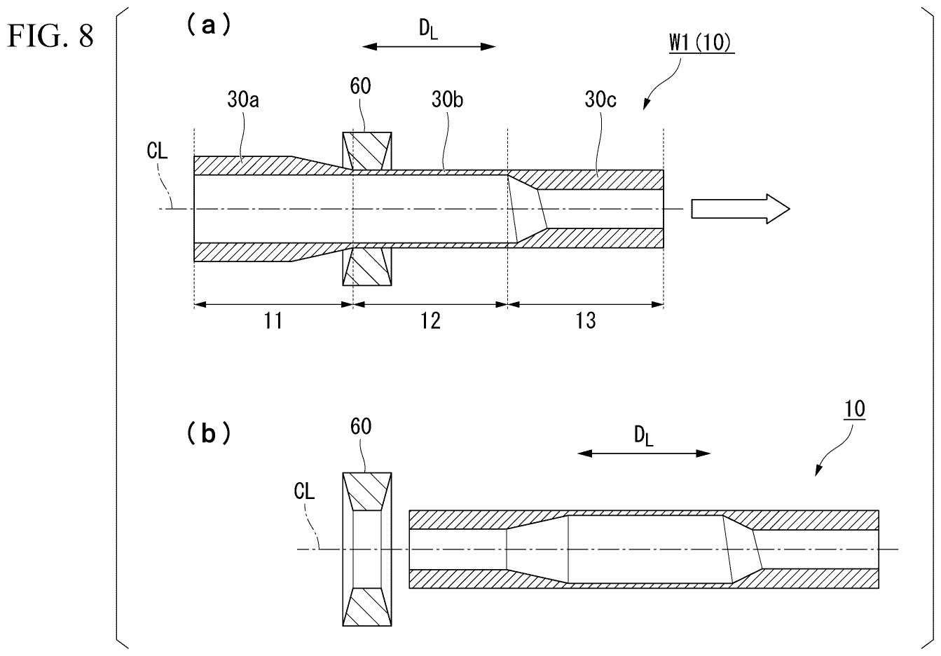

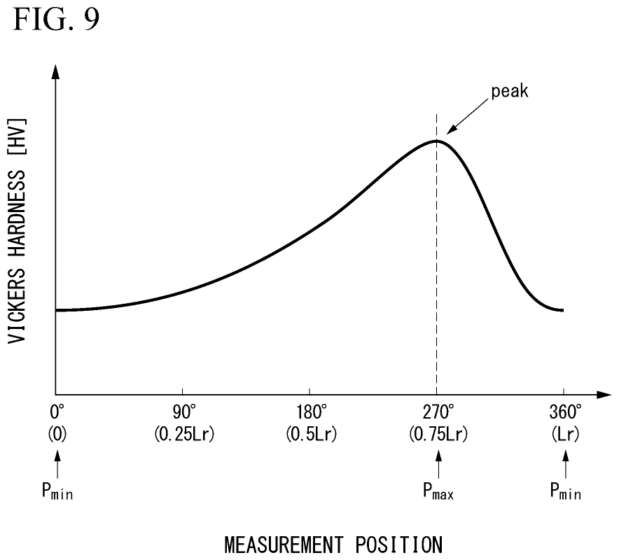

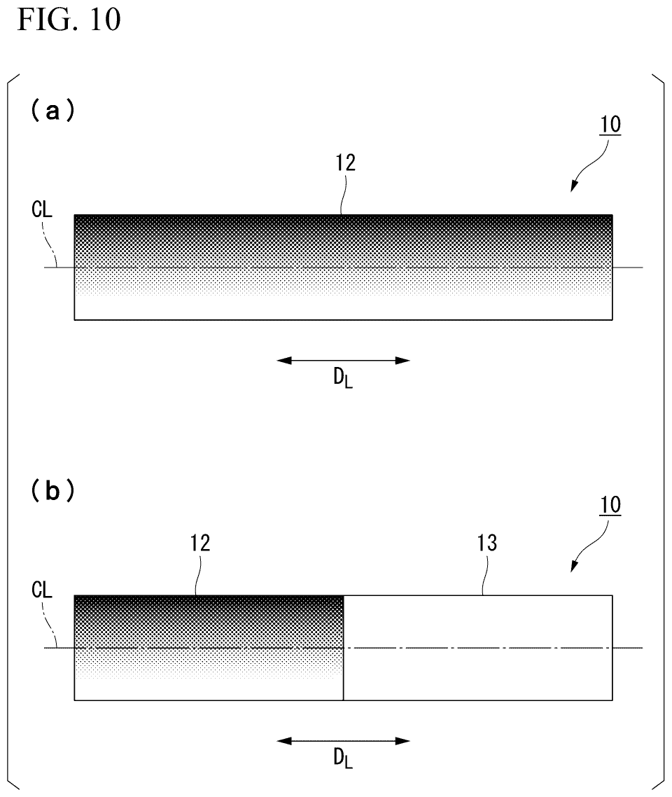

First, a hollow member of the present embodiment will be described with reference to FIGS. 1 to 4. Subsequently, a head portion of a plug used for ironing a raw pipe when manufacturing the hollow member will be described with reference to FIGS. 5 and 6. Subsequently, a hollow member manufacturing method performed using this plug will be described with reference to FIGS. 7 and 8. Finally, a modification example of the present embodiment will be described with reference to FIGS. 9 and 10.

### <Hollow Member>

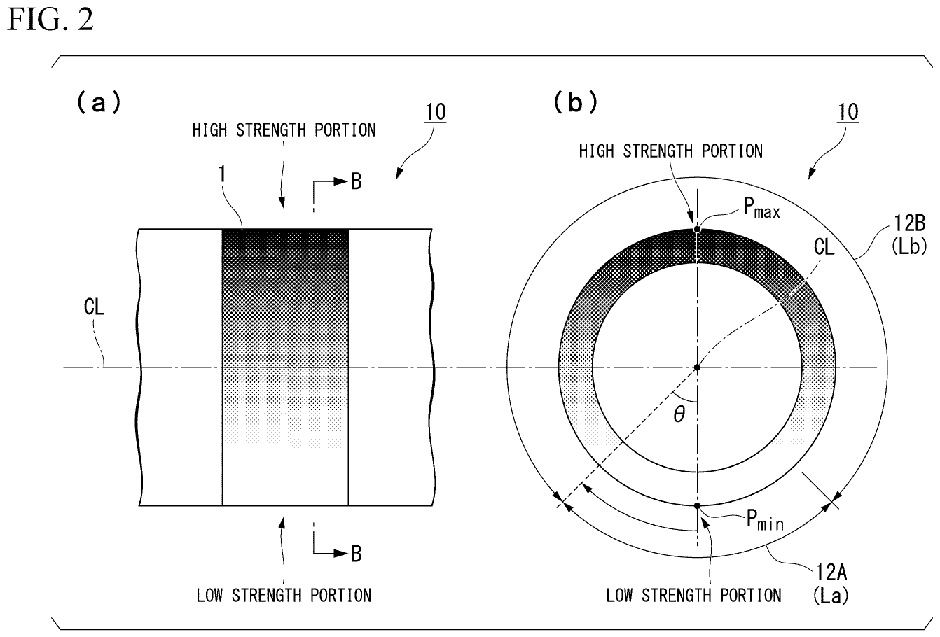

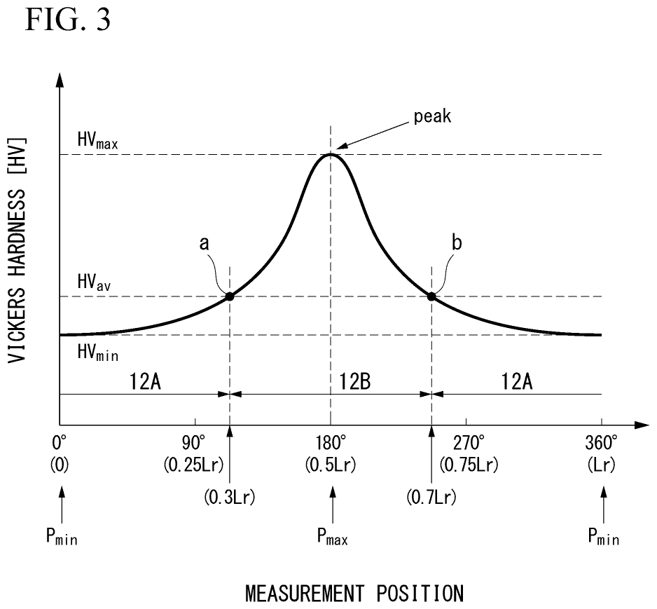

FIG. 1 is a side view of a hollow member 10 according to the present embodiment, and indicates a Vickers hardness distribution in a circumferential direction by gradation. FIG. 2 is a diagram showing a main part of the hollow member 10, in which (a) is an enlarged view of a portion A in FIG. 1, and (b) is a cross-sectional view taken along line B-B in (a). FIG. 3 is a graph showing an example of the Vickers hardness distribution of the hollow member 10, in which a horizontal axis indicates a measurement position in the circumferential direction, and a vertical axis indicates Vickers hardness at each position.

As shown in FIGS. 1 and 2, the hollow member 10 is a metal cylindrical body having a linear central axis CL and being long along the central axis CL. The hollow member 10 is a circular pipe having a circular cross-sectional shape at each position in a total length thereof, and has the same outer diameter dimension, inner diameter dimension, and wall thickness at each position in the longitudinal direction. As specific dimensions, an outer diameter D may be 20 mm to 180 mm, and a wall thickness t may be 0.4 mm to 10 mm. Here, the wall thickness t is uniform in the circumferential direction, and a wall thickness difference, which is a difference between a maximum dimension thereof and a minimum dimension thereof, is preferably 20% or less, and more preferably 10% or less of an average value of the wall thicknesses in the circumferential direction in the same cross section.

Note that, in a case of the hollow member 10 manufactured using a welded pipe obtained by processing a flat sheet into a tubular shape as a raw pipe, the wall thickness of a weld tends to be more non-uniform than a surrounding thereof, and therefore it is necessary to set the wall thickness t and the wall thickness difference described above after excluding the weld. Specifically, in a case of a hollow member having a seam weld, in a cross section perpendicular to a central axis CL thereof, it is preferable to set the wall thickness t and the wall thickness difference described above for a range of 80% excluding both a counterclockwise direction 10° and a clockwise direction 10° with a straight line connecting the central axis CL and a central position of the seam weld in a width direction as a reference. The same applies to a weld other than the seam weld. As a matter of course, in a case of a hollow member manufactured using a raw pipe having no weld, it is preferable to set the wall thickness t and the wall thickness difference described above for 100% of the circumferential direction in the cross section.

As shown in FIG. 1, the hollow member 10 has a first region portion 11, a circumferential hardness difference portion 12, and a second region portion 13 arranged in this order from the left side to the right side of the drawing along the central axis CL. That is, in the present embodiment, the circumferential hardness difference portion 12 is formed only in a center portion in the longitudinal direction. Note that, in FIGS. 1 and 2, in order to clearly indicate the position of the circumferential hardness difference portion 12, a boundary between the circumferential hardness difference portion 12 and the first region portion 11 and a boundary between the circumferential hardness difference portion 12 and the second region portion 13 are indicated using solid lines. However, in practice, such a boundary cannot be confirmed only by visual observation in many cases, and can be confirmed by measuring a Vickers hardness distribution in each portion.

The Vickers hardness in the present disclosure is measured on the basis of JIS Z 2244:2020 in a cross section perpendicular to the central axis CL. A pushing load at the time of measurement is 1 kgf. Note that, when an interval between indentations cannot satisfy the standard defined in JIS Z 2244:2020 due to an excessively large pushing load, the pushing load may be 100 gf. A measurement interval is 10° or less or 5 mm or less along the circumferential direction as long as the interval between the indentations satisfies the standard defined in JIS Z 2244:2020. Note that, when the interval between the indentations cannot satisfy the standard defined in JIS Z 2244:2020, Vickers hardness is measured in two cross sections as follows. That is, first, a part of the hollow member is cut out to obtain a cut portion, and two cut surfaces on both sides of the cut portion are measured. In one of these cut surfaces, the Vickers hardness is measured every 0° to 20° in the circumferential direction, and in the other cut surface, the Vickers hardness is measured every 10° to 20° in the circumferential direction. The measurement position is basically a thickness center portion.

For the hollow member 10 manufactured from a raw pipe having a weld, similarly to the measurement of the wall thickness t described above, in a cross section perpendicular to a central axis CL thereof, it is preferable to measure the Vickers hardness for a range of 80% excluding both a counterclockwise direction 10° and a clockwise direction 10° with a straight line connecting the central axis CL and a central position of the weld in the circumferential direction as a reference. In a case of a hollow member manufactured using a raw pipe having no weld, in a cross section perpendicular to a central axis CL thereof, the Vickers hardness is measured for 100% of the circumferential direction.

Returning to the description of FIG. 1, the first region portion 11 has a uniform outer diameter, inner diameter, wall thickness, and Vickers hardness at each position in a longitudinal direction thereof and a circumferential direction thereof.

Among these, regarding the wall thickness, at each position of the first region portion 11 in the longitudinal direction, a wall thickness difference obtained by subtracting an absolute minimum value of the wall thickness from an absolute maximum value thereof in a circumferential direction of a cross section perpendicular to the central axis CL is 20% or less of an average value of the wall thickness in the circumferential direction of the cross section. The Vickers hardness does not have a hardness distribution in the circumferential direction and is uniform. That is, in the first region portion 11, an average value of the Vickers hardness in a circumferential direction of a cross section perpendicular to the central axis CL is constant at each position in a longitudinal direction thereof. Note that, in a case where the first region portion 11 includes a weld, the description regarding the wall thickness and the Vickers hardness is applied to a portion excluding the weld.

The first region portion 11 is a region having no regular hardness distribution. A material of the first region portion 11 is the same as a material of the circumferential hardness difference portion 12. The first region portion 11 is a region having a higher deformation resistance than the circumferential hardness difference portion 12, and is a region where deformation hardly occurs when a load along an axial direction is applied thereto. The Vickers hardness and the wall thickness of the first region portion 11 are not particularly limited as long as a deformation resistance higher than that of the circumferential hardness difference portion 12 is obtained. Each of the Vickers hardness and the wall thickness in the first region portion 11 may be uniform or non-uniform in the longitudinal direction. Note that the deformation resistance can be evaluated by, for example, ease of deformation when a measurement target portion in the first region portion 11 is cut out and a load is applied thereto in an axial direction. Therefore, ease of deformation for the first region portion 11 and ease of deformation for the circumferential hardness difference portion 12 are obtained and compared with each other. Out of these, one that is relatively less likely to be deformed can be evaluated as having a higher relative deformation resistance, and one that is relatively likely to be deformed can be evaluated as having a lower relative deformation resistance.

In a circumferential direction of the first region portion 11, an absolute maximum value of the Vickers hardness is represented by HV1ₘₐₓ, and an absolute minimum value of the Vickers hardness is represented by HV1ₘᵢₙ. In this case, a difference ΔHV1 obtained by subtracting HV1ₘᵢₙ from HV1ₘₐₓ is, for example, less than HV. The difference ΔHV1 may be 10 HV or less.

In a circumferential direction of the circumferential hardness difference portion 12 to be described later, an absolute maximum value of the Vickers hardness is represented by HV2ₘₐₓ, an absolute minimum value of the Vickers hardness is represented by HV2ₘᵢₙ, and a difference obtained by subtracting HV2ₘᵢₙ from HV2ₘₐₓ is represented by ΔHV2. In this case, ΔHV1 is smaller than ΔHV2. In addition, a difference obtained by subtracting ΔHV1 from ΔHV2 may be preferably 3 HV or more, more preferably 5 HV or more, and most preferably 10 HV or more.

The wall thickness of the first region portion 11 in the circumferential direction may be the same as the wall thickness of the circumferential hardness difference portion 12 in the circumferential direction, or may be larger than the wall thickness of the circumferential hardness difference portion 12 in the circumferential direction. The wall thickness of the first region portion 11 in the circumferential direction may be uniform. Specifically, in the circumferential direction of the first region portion 11, when an absolute maximum value of the wall thickness is represented by T1ₘₐₓ, and an absolute minimum value of the wall thickness is represented by T1ₘᵢₙ, a difference obtained by subtracting T1ₘᵢₙ from T1ₘₐₓ may be 0.50 mm or less. On the other hand, the first region portion 11 may have different wall thicknesses in a longitudinal direction thereof.

Note that the cross-sectional shape of the first region portion 11 (the shape of a cross section orthogonal to the longitudinal direction) is not particularly limited, and examples thereof include a circular shape such as a perfect circle or an ellipse, and a polygonal shape such as a rectangle. The polygonal shape referred to herein includes not only a strict polygonal shape but also a shape in which a portion corresponding to a corner of a polygonal shape has an arc shape.

The second region portion 13 also has the same constitution as the first region portion 11. That is, the second region portion 13 also has a uniform outer diameter, inner diameter, wall thickness, and Vickers hardness at each position in a longitudinal direction thereof and a circumferential direction thereof. Among these, regarding the wall thickness, at each position in a longitudinal direction of the second region portion 13, a wall thickness difference obtained by subtracting an absolute minimum value of the wall thickness from an absolute maximum value thereof in a circumferential direction of a cross section perpendicular to the central axis CL is 20% or less of an average value of the wall thickness in the circumferential direction of the cross section. The Vickers hardness does not have a hardness distribution in the circumferential direction and is uniform. That is, in the second region portion 13, an average value of the Vickers hardness in a circumferential direction of a cross section perpendicular to the central axis CL is constant at each position in a longitudinal direction thereof. Note that, in a case where the second region portion 13 includes a weld, the description regarding the wall thickness and the Vickers hardness is applied to a portion excluding the weld.

Similarly to the first region portion 11, the second region portion 13 is a region having no regular hardness distribution. A material of the second region portion 13 is the same as a material of the circumferential hardness difference portion 12. The second region portion 13 is a region having a higher rigidity than the circumferential hardness difference portion 12, and is a region where deformation hardly occurs when a load along an axial direction is applied thereto. The Vickers hardness and the wall thickness of the second region portion 13 are not particularly limited as long as a deformation resistance higher than that of the circumferential hardness difference portion 12 is obtained. Each of the Vickers hardness and the wall thickness in the second region portion 13 may be uniform or non-uniform in the longitudinal direction. Note that the deformation resistance can be evaluated by, for example, ease of deformation when a measurement target portion in the second region portion 13 is cut out and a load is applied thereto in an axial direction. Therefore, ease of deformation for the second region portion 13 and ease of deformation for the circumferential hardness difference portion 12 are obtained and compared with each other. Out of these, one that is relatively less likely to be deformed can be evaluated as having a higher relative deformation resistance, and one that is relatively likely to be deformed can be evaluated as having a lower relative deformation resistance.

In a circumferential direction of the second region portion 13, an absolute maximum value of the Vickers hardness is represented by HV3ₘₐₓ, and an absolute minimum value of the Vickers hardness is represented by HV3ₘᵢₙ. In this case, a difference ΔHV3 obtained by subtracting HV3ₘᵢₙ from HV3ₘₐₓ is, for example, less than HV. The difference ΔHV3 may be 10 HV or less.

In comparison with the circumferential hardness difference portion 12 to be described later, ΔHV3 is smaller than ΔHV2. In addition, a difference obtained by subtracting ΔHV3 from ΔHV2 may be preferably 3 HV or more, more preferably 5 HV or more, and most preferably 10 HV or more.

The wall thickness of the second region portion 13 in the circumferential direction may be the same as the wall thickness of the circumferential hardness difference portion 12 in the circumferential direction, or may be larger than the wall thickness of the circumferential hardness difference portion 12 in the circumferential direction. The wall thickness of the second region portion 13 in the circumferential direction may be uniform. In the circumferential direction of the second region portion 13, when an absolute maximum value of the wall thickness is represented by T3ₘₐₓ, and an absolute minimum value of the wall thickness is represented by T3ₘᵢₙ, a difference obtained by subtracting T3ₘᵢₙ from T3ₘₐₓ may be 0.50 mm or less. On the other hand, the second region portion 13 may have different wall thicknesses in a longitudinal direction thereof.

Note that the cross-sectional shape of the second region portion 13 (the shape of a cross section orthogonal to the longitudinal direction) is not particularly limited, and examples thereof include a circular shape such as a perfect circle or an ellipse, and a polygonal shape such as a rectangle. The polygonal shape referred to herein includes not only a strict polygonal shape but also a shape in which a portion corresponding to a corner of a polygonal shape has an arc shape.

The circumferential hardness difference portion 12 may have the same outer diameter, the same inner diameter, and the same wall thickness as the first region portion 11 and the second region portion 13, but has a different Vickers hardness distribution from the first region portion 11 and the second region portion 13. That is, regarding the wall thickness of the circumferential hardness difference portion 12, at each position in a longitudinal direction thereof, a wall thickness difference obtained by subtracting an absolute minimum value of the wall thickness from an absolute maximum value thereof in a circumferential direction of a cross section perpendicular to the central axis CL is 20% or less (preferably 10% or less) of an average value of the wall thickness in the whole circumference of the cross section. Note that the average value referred to herein is not an average value of the absolute maximum value and the absolute minimum value, but is a value obtained by obtaining a wall thickness distribution along the whole circumference in the circumferential direction and integrating and averaging the wall thickness distribution.

When the outer diameter of the hollow member 10 is, for example, 20 mm to 180 mm and the average wall thickness is, for example, 0.4 to 10 mm, the wall thickness difference is preferably 0.10 mm or less, more preferably 0.05 mm or less, and most preferably 0.03 mm or less.

As for the Vickers hardness of the circumferential hardness difference portion 12, as shown in FIGS. 1, 2(a), and 2(b), a lower side of the drawing is a relatively soft low strength portion, and an upper side of the drawing is a relatively hard high strength portion. As described above, the circumferential hardness difference portion 12 has a hardness distribution along the circumferential direction at each position in a longitudinal direction thereof.

An example of the hardness distribution in the circumferential hardness difference portion 12 is shown in FIG. 3. A measurement position indicated by a horizontal axis in FIG. 3 is expressed using an angle θ (0°≤θ≤) 360° from a reference (0°), which is a position Pₘᵢₙ at which an absolute minimum value is obtained when the Vickers hardness is measured in the cross section shown in FIG. 2(b) at each position along a circumferential direction thereof. As described later, the measurement position can also be indicated using a whole circumferential length Lr (mm) of the circumferential hardness difference portion 12. For example, the position Pₘᵢₙ in FIG. 3 can be expressed as 0×Lr (mm)=0 (mm), and a position Pₘₐₓ can be expressed as 0.5×Lr (mm). In FIG. 3, in addition to the measurement position using the angle θ, the measurement position using the whole circumferential length Lr (mm) is also shown.

As shown in FIG. 3, in a hardness distribution of the present embodiment, the Vickers hardness is an absolute minimum value (HVₘᵢₙ) at the angle θ=0° (Pₘᵢₙ), the Vickers hardness also increases with an increase in the angle θ, and the Vickers hardness is an absolute maximum value (HVₘₐₓ) at the angle θ=180° (Pₘₐₓ). As the angle θ increases beyond 180°, the Vickers hardness decreases and returns to the absolute minimum value (HVₘᵢₙ) at an angle θ=360° (Pₘᵢₙ). As described above, the circumferential hardness difference portion 12 has a hardness distribution in which the Vickers hardness regularly changes in a circumferential direction thereof. In the circumferential hardness difference portion 12, a hardness difference ΔHV obtained by subtracting the absolute minimum value HVₘᵢₙ of the Vickers hardness from the absolute maximum value HVₘₐₓ thereof is 15 HV or more.

By having the hardness distribution, as shown in FIGS. 2(a) and 2(b), the circumferential hardness difference portion 12 has a low strength range 12A and a high strength range 12B at each position in a longitudinal direction thereof.

When an average of integration of the Vickers hardness in a circumferential direction of a cross section perpendicular to the central axis CL is represented by a hardness threshold HVₐᵥ, the low strength range 12A is defined as a range in which the Vickers hardness is equal to or less than the hardness threshold HVₐᵥ at each position in the circumferential direction.

On the other hand, the high strength range 12B is defined as a range in which the Vickers hardness is more than the hardness threshold HVₐᵥ at each position in the circumferential direction.

As shown in FIG. 3, the low strength range 12A includes a portion where the Vickers hardness gradually increases starting from the measurement position Pₘᵢₙ at which the Vickers hardness is an absolute minimum value and is continuous with one end of the high strength range 12B, and a portion where the Vickers hardness is continuous with the other end of the high strength range 12B, gradually decreases, and returns to the measurement position Pₘᵢₙ.

In the high strength range 12B, the Vickers hardness is the absolute maximum value HVₘₐₓ at a substantially central measurement position Pₘₐₓ along a circumferential direction thereof. Then, the Vickers hardness gradually decreases toward the left and right in the circumferential direction with the measurement position Pₘₐₓ as a center, and is continuous with the low strength range 12A.

The measurement position Pₘᵢₙ in the low strength range 12A and the measurement position Pₘₐₓ in the high strength range 12B will be described more specifically below.

When the whole outer circumferential length of the circumferential hardness difference portion 12 is represented by Lr (mm), and the position Pₘᵢₙ at which the Vickers hardness is an absolute minimum value in the low strength range 12A is used as a reference, the position Pₘₐₓ at which the Vickers hardness is an absolute maximum value is within the high strength range 12B which is a range of 0.3×Lr (mm) to 0.7×Lr (mm) (more preferably a range of 0.4×Lr (mm) to 0.6×Lr (mm)). In the present embodiment, as shown in FIG. 2(b), a case where the position Pₘᵢₙ and the position Pₘₐₓ face each other with the central axis CL interposed therebetween is exemplified. Therefore, in FIG. 3, as measurement positions, the position Pₘᵢₙ is set at a position of 0° (0×Lr) or 360° (1.0×Lr), and the position Pₘₐₓ is set at a position of 180° (0.5×Lr).

As shown in FIG. 3, the low strength range 12A and the high strength range 12B are connected to each other at two points a and b where the Vickers hardness at both ends of the low strength range 12A and the Vickers hardness at both ends of the high strength range 12B are equal to each other. In the present embodiment, a range of 0° (0×Lr) to 108° (0.3×Lr) and a range of 252° (0.7×Lr) to 360° (1.0×Lr) as measurement positions are set as the low strength range 12A. A range of more than 108° (0.3×Lr) and less than 252° (0.7×Lr) is set as the high strength range 12B.

In the cross section shown in FIG. 2(b), a ratio of a circumferential length La (mm) of the low strength range 12A to the whole outer circumferential length Lr (mm) is within a range of 20% to 80%, and it is preferable to set the ratio to 30% to 70% because a more remarkable effect can be obtained. Therefore, a ratio of a circumferential length Lb (mm) of the high strength range 12B to the whole outer circumferential length Lr (mm) is a value obtained by subtracting the ratio of the circumferential length La (mm) from 100%.

Note that, in a case where the circumferential hardness difference portion 12 includes a weld, the description regarding the wall thickness and the Vickers hardness are applied to a portion excluding the weld.

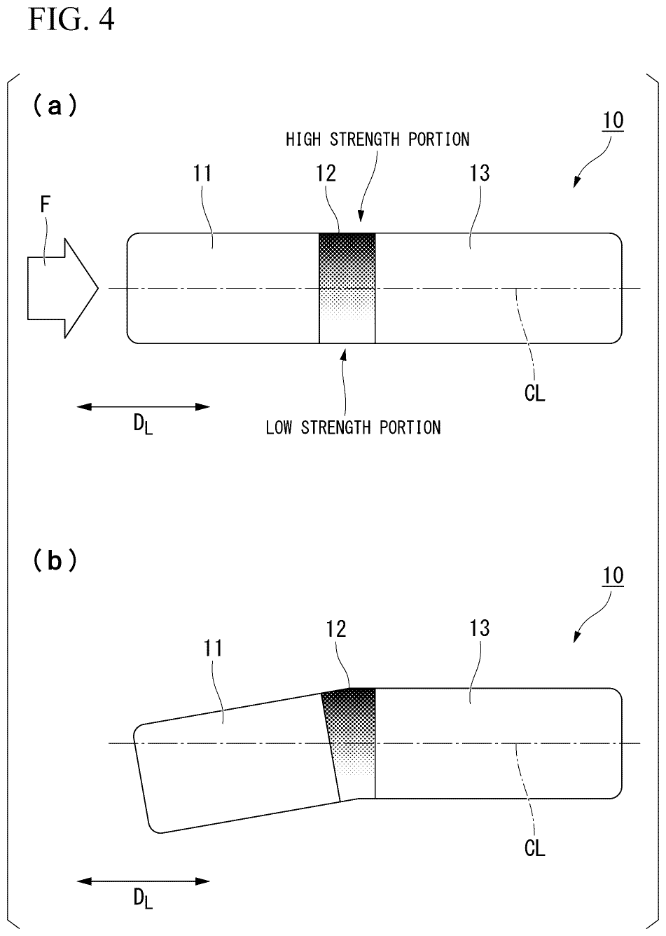

According to the hollow member 10 of the present embodiment having the above constitution, robustness can be enhanced without deteriorating component performance during normal operation. This will be described below with reference to FIGS. 4(a) and 4(b). Note that FIG. 4 is a side view showing a case where a load F is applied to the hollow member 10, in which (a) shows a state before the load F is applied, and (b) shows a state after the load F is applied.

As shown in FIGS. 4(a) and 4(b), the hollow member 10 includes the first region portion 11, the circumferential hardness difference portion 12, and the second region portion 13 in this order along a longitudinal direction thereof. As shown in FIG. 4(a), it is assumed that a load F is applied to a distal end portion of the first region portion 11 of the hollow member 10 along the central axis CL. If the load F at this time is a value during normal operation, the hollow member 10 receives the load without being bent and deformed. Here, the circumferential hardness difference portion 12 has the relatively soft low strength range 12A and the relatively hard high strength range 12B in a circumferential direction thereof, but both the low strength range 12A and the high strength range 12B support an external force within a range of elastic deformation with respect to a load during normal operation, and therefore component performance is not deteriorated. Therefore, the hollow member 10 continues to maintain a function as a strength member while maintaining the linear shape shown in FIG. 4(a).

On the other hand, when the load F applied in FIG. 4(a) is an impact force or the like stronger than that during normal operation, as shown in FIG. 4(b), in the circumferential hardness difference portion 12, the low strength range 12A is bent and deformed more preferentially than the high strength range 12B. At this time, in the circumferential hardness difference portion 12, the low strength range 12A having a relatively lower Vickers hardness than the high strength range 12B is plastically deformed positively. As a result, the hollow member 10 is bent and deformed such that the low strength range 12A is on a recess side and the high strength range 12B is on a protrusion side, and absorbs energy in the process of plastic deformation. As described above, a bending direction of the hollow member 10 can be set by a relative positional relationship between the low strength range 12A and the high strength range 12B. Therefore, even when a direction of application of the load F has a slight angle with respect to the central axis CL, a position of application of the load F is slightly shifted with respect to the central axis CL, or a direction of a reaction force against the load F slightly fluctuates, the hollow member 10 can be bent and deformed in an intended direction. As a result, a stable bending deformation mode can be achieved, and therefore robustness of deformation against a collision condition is enhanced.

As described above, in order to enhance the robustness of deformation against the collision condition, conventionally, measures such as bending the hollow member in advance have been considered. However, in these cases, there may be inconvenience that component performance during normal operation is deteriorated, the number of manufacturing steps is increased, or a component application is limited.

On the other hand, since the hollow member 10 of the present embodiment is not bent, a stable bending deformation mode can be achieved. In addition, in the hollow member 10, since the wall thickness of the circumferential hardness difference portion 12 is uniform along the circumferential direction, component rigidity during normal operation is also uniform in the circumferential direction, and there is an advantage that deformation hardly concentrates at one place. For example, in a case where the wall thickness of a hollow member is non-uniform along the circumferential direction, when twisting as an external force is applied to the hollow member, such a difference that the hollow member is largely warped at a portion where the wall thickness is thin but hardly warped at a portion where the wall thickness is thick occurs between the portions. In particular, in a case where out-of-plane deformation also occurs, a cube of a difference in wall thickness affects ease of deformation, and therefore the out-of-plane deformation tends to concentrate at a portion where the wall thickness is thin. On the other hand, in the hollow member 10 of the present embodiment, since the wall thickness of the circumferential hardness difference portion 12 is uniform along the circumferential direction, such inconvenience can be avoided.

Although it is difficult to distinguish the hollow member 10 described above only by an external appearance, the hollow member 10 can be confirmed by the following method.

First, presence or absence of the circumferential hardness difference portion 12 having a hardness difference and a uniform wall thickness in the circumferential direction is confirmed. Here, the “circumferential direction” refers to a direction along an outer circumference of the cylindrical shape in a cross section orthogonal to a longitudinal direction. The “hardness difference” refers to a Vickers hardness distribution described below.

First, the Vickers hardness is measured along the circumferential direction along the whole circumference of 360°. Then, as shown in FIG. 3, a graph in which a measurement position (circumferential direction angle θ) is taken on the horizontal axis and a Vickers hardness is taken on the vertical axis is created. This graph may be created by approximating plot data with a quadratic curve, or may be created by approximating plot data with a primary straight line. In the created graph, the circumferential length La (mm) of the range satisfying the above-described low strength range 12A is obtained. Finally, a ratio of the circumferential length La (mm) to the whole outer circumferential length Lr (mm) is obtained, and a case where the ratio is within a range of 20% to 80% is defined as having a hardness difference. Note that the “hardness difference” is defined excluding a weld (for example, a joint portion of an electric resistance welded pipe).

Note that, in the circumferential direction of the circumferential hardness difference portion 12, the difference ΔHV between the absolute maximum value HVₘₐₓ of the Vickers hardness and the absolute minimum value HVₘᵢₙ of the Vickers hardness is set to 15 HV or more, but may be 20 HV or more or 30 HV or more. When ΔHV is too small, the bending direction is not fixed, and good robustness cannot necessarily be obtained. On the other hand, as an upper limit of ΔHV, for example, 120 HV can be exemplified. Values of HVₘₐₓ and HVₘᵢₙ are not particularly limited, but may be each, for example, 80 HV or more, 150 HV or more, or 200 HV or more as long as the above-described ΔHV can be ensured therebetween.

Note that the Vickers hardness (HV) may be converted into tensile strength (TS) on the basis of JIS Handbook Steel I. In addition, regarding steel, within a range of 100 HV or more and 400 HV or less, conversion can be performed by an approximate expression of TS [MPa]≈3.12×HV+16.

In this case, in the circumferential direction of the circumferential hardness difference portion 12, an absolute maximum value of the tensile strength is represented by TSₘₐₓ, and an absolute minimum value of the tensile strength is represented by TSₘᵢₙ. A difference (ATS) between TSₘₐₓ and TSₘᵢₙ is, for example, 40 MPa or more, and may be 80 MPa or more. On the other hand, ATS is, for example, 390 MPa or less. Values of TSₘₐₓ and TSₘᵢₙ are not particularly limited, but may be each, for example, 270 MPa or more, 490 MPa or more, or 680 MPa or more as long as the above-described ΔTS can be ensured therebetween.

As described above, instead of defining the measurement position for indicating the hardness distribution by using the angle θ with the position Pₘᵢₙ at which the Vickers hardness is the absolute minimum value (HVₘᵢₙ) as a reference (0°), the measurement position may be defined by using the whole circumferential length Lr (mm) of the outer circumference of the circumferential hardness difference portion 12. In this case, the measurement position can be defined by x×Lr (0≤x≤1) with the position Pₘᵢₙ as a reference (0 mm).

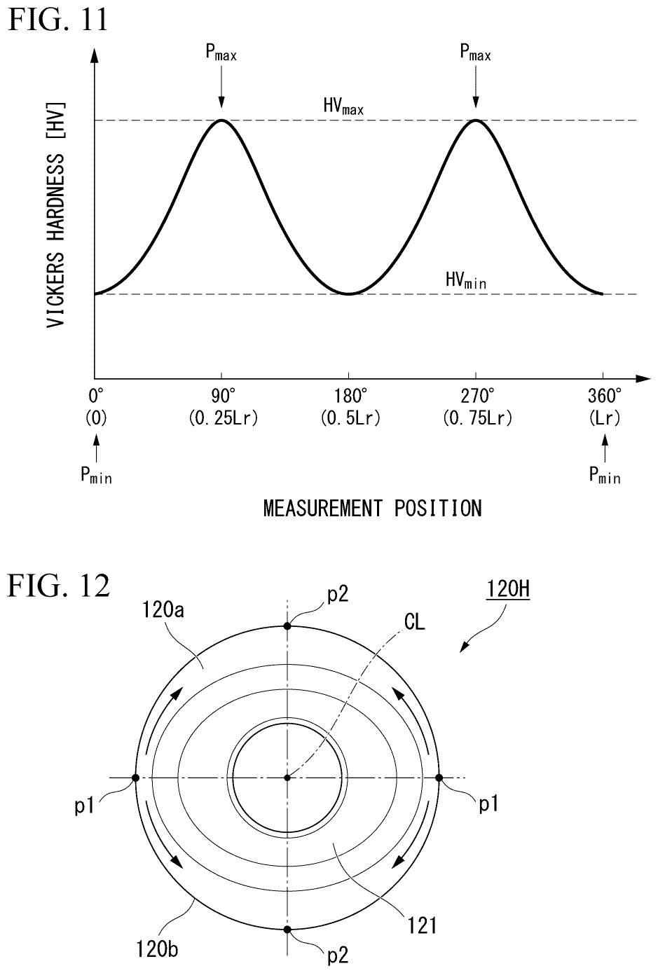

Specifically, in the circumferential hardness difference portion 12, by measuring the Vickers hardness along the circumferential direction for the whole circumference, a change in the Vickers hardness at each measurement position starting from Pₘᵢₙ (measurement position 0 mm) is obtained. For example, FIG. 3 shows a change in the Vickers hardness at each position of x×Lr (0≤x≤1), and there is one peak of the Vickers hardness. In this case, the position of the peak coincides with the position Pₘₐₓ at which the Vickers hardness is the absolute maximum value HVₘₐₓ. There may be a plurality of peaks of the Vickers hardness. For example, in FIG. 11 to be described later, there are two peaks of the Vickers hardness. In a case where there are a plurality of peaks, values of the Vickers hardness at the plurality of peaks may be the same as each other as shown in FIG. 11, or may be different from each other. In the latter case, a position having the highest Vickers hardness among the peaks is Pₘₐₓ.

In FIG. 3, the peak of the Vickers hardness is present at a position of 0.5×Lr with the measurement position Pₘᵢₙ as a reference. As described above, the position of the peak of the Vickers hardness is preferably set to a position of 0.3×Lr or more and 0.7×Lr or less from a viewpoint of symmetry. On the other hand, the position of the peak of the Vickers hardness may be present at a position smaller than 0.3×Lr or a measurement position larger than 0.7×Lr. For example, in FIG. 9 to be described later, the position of the peak of the Vickers hardness is present at a position of 0.75×Lr with Pₘᵢₙ as a reference.

Note that the cross-sectional shape of the circumferential hardness difference portion 12 (the shape of a cross section orthogonal to the longitudinal direction) is not particularly limited, and examples thereof include a circular shape such as a perfect circle or an ellipse, and a polygonal shape such as a rectangle. The polygonal shape referred to herein includes not only a strict polygonal shape but also a shape in which a portion corresponding to a corner of a polygonal shape has an arc shape.

### <Plug>

Subsequently, a plug 20 used for ironing a raw pipe when manufacturing the hollow member 10 described above will be described below. The plug 20 has a head portion 20H shown in FIGS. 5 and 6 and a shaft portion 20S shown in FIG. 7. FIG. 5 is a diagram showing the head portion 20H of the plug 20, in which (a) is a perspective view viewed from a distal end side thereof, and (b) is a perspective view viewed from a rear end side thereof. FIG. 6 is a diagram showing the head portion 20H, in which (a) is a side view, and (b) is a front view. As shown in FIG. 7, the head portion 20H is coaxially fixed to a distal end of the shaft portion 20S.

The head portion 20H shown in FIGS. 5 and 6 includes a tapered portion (distal end portion) 20a having a distal end surface 21 and a parallel portion (main body portion) 20b. The parallel portion 20b usually has an outer shape dimension larger than an inner shape dimension of a raw pipe to be described later and smaller than an inner shape dimension of a first structure portion 40a of a die 40 to be described later. Note that, in the present disclosure, when the raw pipe and the hollow member 10 each have a circular cross section, dimensions thereof are indicated by “inner diameter dimension” and “outer diameter dimension”, but the raw pipe and the hollow member 10 of the present disclosure are not limited to only a case where the raw pipe and the hollow member 10 of the present disclosure each have a circular cross section. Therefore, in the present specification, as dimensions including dimensions other than a circular cross section, such as a rectangular cross section, “inner shape dimension” and “outer shape dimension” may be described as described above.

As shown in FIG. 6(a), in the head portion 20H, a length L in a longitudinal direction D_{A} along a central axis CL from the distal end surface 21 to a taper start point t in a side view varies depending on a position of the head portion 20H in a circumferential direction. A taper start point at which the length L is the longest Lₘₐₓ is represented by t1, and a taper start point at which the length Lis the shortest Lₘᵢₙ is represented by t2. In the head portion 20H, with a difference between Lₘₐₓ and Lₘᵢₙ, a direction D_{B} connecting the taper start points t1 and t2 in a side view diagonally intersects the longitudinal direction D_{A} without being orthogonal to the longitudinal direction D_{A}.

The head portion 20H includes the tapered portion 20a that is tapered toward a push-in direction, and a parallel portion 20b that is continuous with a rear end of the tapered portion 20a and has a maximum outer shape dimension (outer diameter dimension) in a cross section perpendicular to the push-in direction. In the side view shown in FIG. 6(a), a connection surface CS including a connection line between the tapered portion 20a and the parallel portion 20b is inclined with respect to a virtual surface VS orthogonal to a central axis CL of the head portion 20H. As shown in FIG. 6(b), the taper start points t1 and t2 are located on the connection line so as to face each other with the central axis CL interposed therebetween.

In the side view shown in FIG. 6(a), an angle (acute angle) formed between a direction D_{B} and a direction D_{A} is, for example, 50° or less, and may be 45° or less. Note that, in the side view shown in FIG. 6(a), the taper angle θ at each taper start point t is the same at each position of the head portion 20H in the circumferential direction.

By using the head portion 20H having the above-described tapered shape for the plug 20, movement of a material along the circumferential direction can be caused at the time of ironing a raw pipe. Specifically, a material of a raw pipe inner wall hit on the taper start point t2 moves from the taper start point t2 toward the taper start point t1 along a circumferential direction of the raw pipe inner wall. Therefore, in the raw pipe inner wall, a wall thickness reduction ratio decreases around the taper start point t2, and a thin wall portion having a low Vickers hardness is formed. On the other hand, around the taper start point t1, the material of the raw pipe inner wall gathers from a surrounding, and therefore the wall thickness reduction ratio increases, and a thin wall portion having a high Vickers hardness is formed. Therefore, by ironing the raw pipe using the plug 20 including the head portion 20H, the circumferential hardness difference portion 12 having a hardness distribution in the circumferential direction can be formed in the manufactured hollow member 10. On the other hand, an outer shape dimension of the parallel portion 20b is constant regardless of the position of the taper start point t. Therefore, as shown in FIG. 7, an interval between an outer circumferential surface of the parallel portion 20b and an inner circumferential surface of the die 40 is constant in the circumferential direction with the central axis CL as a center. Therefore, the circumferential hardness difference portion 12 having a uniform thickness in the circumferential direction can be formed in the hollow member 10.

### <Hollow Member Manufacturing Method>

Next, a hollow member manufacturing method for manufacturing the hollow member 10 from a hollow cylindrical raw pipe 30 using the plug 20 described above will be described with reference to FIGS. 7 and 8. FIG. 7 is a cross-sectional view showing a first half of the hollow member manufacturing method using the plug 20 having the head portion 20H in chronological order of (a) to (c). Here, (a) shows a raw pipe disposition step, (b) shows a locking step, and (c) shows an ironing step. FIG. 8 is a cross-sectional view showing a latter half of the hollow member manufacturing method following FIG. 7(c) in chronological order of (a) and (b). Here, (a) shows a start time of a drawing step, and (b) shows a completion time thereof.

As the raw pipe 30 used in the present embodiment, a raw pipe having a tensile strength of 290 MPa or more is suitably used. For example, as the raw pipe 30, a raw pipe having a tensile strength of 440 MPa or 980 MPa is used. A material of the raw pipe 30 is not limited to steel, and may be another metal such as aluminum. The raw pipe 30 is, for example, a hollow cylindrical metal pipe (including a steel pipe). The raw pipe 30 is particularly preferably a round steel pipe. The round steel pipe may be any of a seamless steel pipe, a UO pipe, a spiral pipe, and an electric resistance welded steel pipe. A cross-sectional shape of the raw pipe 30 perpendicular to a longitudinal direction thereof may be any of a circular shape, an elliptical shape, a rectangular shape, and the like.

In the raw pipe disposition step shown in FIG. 7(a), first, the raw pipe 30 is disposed in the die 40, and furthermore, movement of the raw pipe 30 in the longitudinal direction is restricted by a stopper 50. The die 40 includes the first structure portion 40a having an inner shape dimension (inner diameter) corresponding to an outer shape dimension of the raw pipe 30. In the present disclosure, the “inner shape dimension corresponding to the outer shape dimension of the raw pipe” refers to an inner shape dimension obtained by adding a gap to the outer shape dimension of the raw pipe to such an extent that the raw pipe can be inserted and removed. Furthermore, the die 40 includes a second structure portion 40b having an inner shape dimension (inner diameter) larger than the outer shape dimension of the raw pipe 30 and used for enlarging an outer shape of the raw pipe 30 on one end 30x side.

Next, in the locking step shown in FIG. 7(b), the head portion 20H of the plug is pushed in from the one end 30x side of the raw pipe 30 to enlarge the outer shape of the raw pipe 30 on the one end 30x side to form an enlarged portion 30a, and the raw pipe 30 is locked to the die 40 by the enlarged portion 30a. The head portion 20H of the plug 20 has the distal end surface 21 smaller than the inner shape dimension of the raw pipe 30. The enlarged portion 30a is formed by pushing the head portion 20H of the plug 20, but processing at this time is pipe enlarging and not ironing. Therefore, in the enlarged portion 30a, the hardness distribution in the circumferential direction as shown in FIG. 3 hardly occurs.

Next, in the ironing step shown in FIG. 7(c), the stopper 50 is removed from the inside of the die 40, and the restriction of movement of the raw pipe 30 in the longitudinal direction is released. Furthermore, the head portion 20H of the plug 20 is pushed from the one end 30x side of the raw pipe 30 toward the other end 30y side thereof while locking of the raw pipe 30 is maintained, and ironing to enlarge the inner shape of the raw pipe 30 is applied. As a result, the wall of the raw pipe 30 is thinned to form a thin wall portion 30b. The thin wall portion 30b has a uniform wall thickness in the circumferential direction and a hardness distribution in the circumferential direction. On the other hand, a portion of the raw pipe 30 to which ironing has not been applied is an unprocessed portion 30c.

FIG. 8(a) is a schematic cross-sectional view of an intermediate body W1 obtained through the steps shown in FIGS. 7(a) to 7(c) as viewed in a cross section including a central axis CL thereof. The intermediate body W1 has the first region portion 11, the circumferential hardness difference portion 12, and a portion corresponding to the second region portion 13 along a longitudinal direction DL thereof. The intermediate body W1 may be used as the hollow member 10.

Alternatively, as shown in FIGS. 8(a) and 8(b), a drawing step of causing the enlarged portion 30a in the intermediate body W1 to pass through a die (another die) 60 to reduce the enlarged portion 30a to return the outer shape dimension of the enlarged portion 30a to the original size may be further performed.

The die 60 has an inner shape dimension (inner diameter) corresponding to the outer shape dimension (outer diameter d1) of the raw pipe 30. Since the inner shape dimension is smaller than the outer diameter dimension of the enlarged portion 30a, when the intermediate body W1 is caused to pass through the die 60, the intermediate body W1 is inserted into the die 60 without being caught in the second region portion 13 and the circumferential hardness difference portion 12, but is narrowed in the enlarged portion 30a such that an outer shape thereof decreases.

As a result, as shown in FIG. 8(b), it is possible to obtain the hollow member 10 having a uniform outer shape along the total length in the longitudinal direction and a partially enlarged inner shape. Here, a thick wall portion obtained by reducing the original enlarged portion 30a is the first region portion 11, a thin wall portion continuous with the first region portion 11 and subjected to ironing is the circumferential hardness difference portion 12, and a thick wall portion continuous with the circumferential hardness difference portion 12 and having a wall thickness thicker than the circumferential hardness difference portion 12 is the second region portion 13. As described above, since the circumferential hardness difference portion 12 is thinner than the first region portion 11 and the second region portion 13 that are on both sides thereof, the wall thickness of the circumferential hardness difference portion 12 is the thinnest in the hollow member 10. A tapered portion is formed on an inner wall surface at a connection end of the first region portion 11 with the circumferential hardness difference portion 12. Similarly, a tapered portion is also formed on an inner wall surface at a connection end of the second region portion 13 with the circumferential hardness difference portion 12. These tapered portions absorb a difference in inner shape dimension on the inner wall surface of the hollow member 10.

The intermediate body W1 obtained in FIG. 8(b) may be regarded as the intermediate body W1, and the intermediate body W1 may be pressed to process a cross-sectional shape thereof perpendicular to the longitudinal direction into a shape other than a circular shape. For example, a press working step of performing press forming such that a cross-sectional shape of the intermediate body W1 perpendicular to the longitudinal direction is rectangular may be further performed. In this case, the hollow member 10 having a rectangular cross-sectional shape at each position in the longitudinal direction can be manufactured.

### Modification Examples

The present disclosure is not limited only to the above embodiment. For example, various modification examples described below may be adopted instead of the above embodiment.

In the above embodiment, the drawing process shown in FIG. 8(b) is performed following the ironing step shown in FIG. 7(c). On the other hand, instead of the drawing step, a cutting step of cutting and removing portions corresponding to the first region portion 11 and the second region portion 13 from the intermediate body W1 shown in FIG. 8(a) to leave only the circumferential hardness difference portion 12 may be performed. In this case, it is possible to manufacture the hollow member 10 having a constant wall thickness and a hardness difference distribution in the circumferential direction over the total length.

As shown in FIG. 3, the above embodiment has a positional relationship in which the absolute maximum value of the Vickers hardness and the absolute minimum value thereof face each other with the central axis CL interposed therebetween. Instead of this constitution, as shown in FIG. 9, a constitution in which the absolute maximum value of the Vickers hardness is present at a position of, for example, 270° (0.75×Lr) deviated from 180° (0.5×Lr) with a measurement position of 0° at which the Vickers hardness is the absolute minimum value as a reference may be adopted.

In the above embodiment, as shown in FIG. 1, the constitution in which the circumferential hardness difference portion 12 is formed between the first region portion 11 and the second region portion 13 is adopted. Instead of this constitution, the hollow member 10 shown in FIG. 10(a) may be manufactured by performing the above-described cutting step. A hardness difference distribution in the circumferential direction is imparted to the hollow member 10 over a total length thereof.

Alternatively, in the above-described cutting step, only one of the first region portion 11 and the second region portion 13 may be cut. For example, in FIG. 10(b), only the first region portion 11 is cut and removed, and the circumferential hardness difference portion 12 and the second region portion 13 are left. In this hollow member 10, there is a Vickers hardness distribution in a half in the longitudinal direction, whereas the Vickers hardness in the circumferential direction is uniform in the other half.

The hollow member 10 of the above embodiment shown in FIG. 1 is compared with the hollow member 10 shown in FIGS. 10(a) and 10(b) as a modification example.

As described above, the hollow member 10 shown in FIG. 1 includes the circumferential hardness difference portion 12, and the first region portion 11 and the second region portion 13 formed at both ends of the circumferential hardness difference portion 12 in the longitudinal direction DL. By forming the first region portion 11 and the second region portion 13 having uniform hardness in the circumferential direction at both ends of the circumferential hardness difference portion 12 having a hardness distribution in the circumferential direction, when a load along the axial direction is applied to the hollow member 10, stress tends to concentrate at the circumferential hardness difference portion 12 in a total length thereof. As a result, the hollow member is reliably bent and deformed at the position of the circumferential hardness difference portion 12 in a longitudinal direction thereof, and therefore robustness is higher than that of the hollow member 10 shown in FIGS. 10(a) and 10(b).

In addition, in the hollow member 10 shown in FIG. 1, for example, as compared with the hollow member 10 shown in FIG. 10 (a), when a load is applied thereto in the axial direction, stress tends to concentrate in the low strength range 12A which is a weak portion of the circumferential hardness difference portion 12, and thus, even when a hardness difference between HVₘₐₓ and HVₘᵢₙ in the circumferential hardness difference portion 12 is made smaller than that in the hollow member 10 shown in FIGS. 10(a) and (b), good robustness can be obtained.

When the first region portion 11 and the second region portion 13 are formed at both ends of the circumferential hardness difference portion 12 as in the hollow member shown in FIG. 1, a ratio of the length of the circumferential hardness difference portion 12 to the total length is preferably 5% or more and 50% or less. The length of the circumferential hardness difference portion 12 in the longitudinal direction of the hollow member 10 is preferably 10 mm or more. By adjusting the length of the circumferential hardness difference portion 12, good robustness can be easily obtained.

As described above, the circumferential hardness difference portion 12 may have a plurality of peak positions Pₘₐₓ in the circumferential direction. For example, in a case of FIG. 11, there are two peak positions Pₘₐₓ at which the Vickers hardness is the absolute maximum value HVₘₐₓ. Values of the Vickers hardness at these two positions Pₘₐₓ are the same as each other. Similarly, in the case of FIG. 11, there are also two positions Pₘᵢₙ at which the Vickers hardness is the absolute minimum value HVₘᵢₙ. Values of the Vickers hardness at these two positions Pₘᵢₙ are the same as each other.

In the hardness distribution in the circumferential direction shown in FIG. 11, when viewed along the circumferential direction from a measurement position of 0° of the circumferential hardness difference portion 12, first, the position of 0° is a position Pₘᵢₙ at which the Vickers hardness is the absolute minimum value HVₘᵢₙ. Subsequently, the Vickers hardness increases as the position moves in the circumferential direction from the position Pₘᵢₙ, and the Vickers hardness is the absolute maximum value HVₘₐₓ at a position Pₘₐₓ of 90°. Subsequently, the Vickers hardness decreases as the position moves in the circumferential direction from the position Pₘₐₓ of 90°, and the Vickers hardness is the absolute minimum value HVₘᵢₙ at a position Pₘᵢₙ of 180°. Subsequently, the Vickers hardness increases as the position moves in the circumferential direction from the position Pₘᵢₙ of 180°, and the Vickers hardness is the absolute maximum value HVₘₐₓ at a position Pₘₐₓ of 270°. Finally, the Vickers hardness decreases as the position moves in the circumferential direction from the position Pₘₐₓ of 270°, and the Vickers hardness is the absolute minimum value HVₘᵢₙ when the position reaches a position Pₘᵢₙ of 360°, that is, returns to the measurement position of 0°.

As described above, in the circumferential hardness difference portion 12 in the case of FIG. 11, the Vickers hardness periodically increases or decreases a plurality of times along the circumferential direction. According to such a circumferential distribution, weak portions having low Vickers hardness can be formed at two locations in the circumferential direction, and therefore a bending direction of the hollow member can be intentionally increased to two predetermined directions. Note that the Vickers hardness may increase or decrease in a curved or linear manner.

The circumferential distribution of Vickers hardness shown in FIG. 11 can be imparted by a plug 20 having another head portion 120H shown in FIG. 12.

The head portion 120H shown in FIG. 12 includes a tapered portion (distal end portion) 120a having a distal end surface 121 and a parallel portion (main body portion) 120b. The parallel portion 120b has an outer shape dimension larger than an inner shape dimension of a raw pipe and smaller than an inner shape dimension of the first structure portion 40a of the die 40.

A connection line between the tapered portion 120a and the parallel portion 120b includes a plurality of (two in this modification example) first connection points p1 closest to the distal end surface 121 of the head portion 120H in a side view and a plurality of (two in this modification example) second connection points p2 located between the first connection points p1 in a front view and located farther from the distal end surface 121 than the first connection points p1 in a side view.

That is, when the connection line is viewed along the circumferential direction of the head portion 120H, the connection line moves away from the distal end surface 121 as a position on the connection line proceeds from the first one of the two first connection points p1 closest to the distal end surface 121 along the circumferential direction, and reaches the first one of the second connection points p2 located farthest from the distal end surface 121. Subsequently, the connection line approaches the distal end surface 121 as a position on the connection line proceeds from the first one of the second connection points p2 along the circumferential direction, and reaches the second one of the first connection points p1 located closest to the distal end surface 121. Subsequently, the connection line moves away from the distal end surface 121 as a position on the connection line proceeds from the second one of the first connection points p1 along the circumferential direction, and reaches the second one of the second connection points p2 located farthest from the distal end surface 121. Finally, the connection line approaches the distal end surface 121 as a position on the connection line proceeds from the second one of the second connection points p2 along the circumferential direction, and reaches the first one of the first connection points p1 closest to the distal end surface 121.

As described above, the head portion 120H in which the connection line repeatedly approaches and moves away from the distal end surface 121 as a position on the connection line proceeds along the circumferential direction may be adopted. In this case, each of the number of the first connection points p1 and the number of the second connection points p2 is not limited to two, and may be three or more.

When the ironing shown in FIG. 7(c) is performed using the plug 20 having the head portion 120H shown in FIG. 12, a flow of a material directed in the direction indicated by the arrow in FIG. 12 can be formed along a surface of the tapered portion 120a.

A reason why such a flow of material can be formed during ironing will be described. Since the head portion 120H includes the connection line described above, in a push-in direction of the head portion 120H, a timing when the first connection points p1 iron the inner wall of the raw pipe 30 can be made earlier than a timing when the second connection points p2 iron the inner wall of the raw pipe 30. That is, among points on the connection line, the first connection points p1 on a distal end side in the push-in direction iron the inner wall earlier, and the second connection points p2 on a rear end side in the push-in direction iron the inner wall later. As a result, a previously ironed material moves along the circumferential direction and goes to a region to be ironed later. In this way, on the inner wall after the ironing, two high strength ranges 12B where the material concentrates and the Vickers hardness is increased and two low strength ranges 12A where the material flows out and the Vickers hardness is relatively lowered are formed. As a result, the circumferential distribution of Vickers hardness shown in FIG. 11 is formed.

An application of the hollow member 10 in the present disclosure is not particularly limited, and examples thereof include a vehicle component. Examples of the vehicle component include: a frame member such as a cross member, a suspension member, a suspension arm, a frontside member, or a rear side member; a collision handling component such as a perimeter or a side impact bar; and a drive system pipe component such as a drive shaft.

### EXAMPLES

### First Example

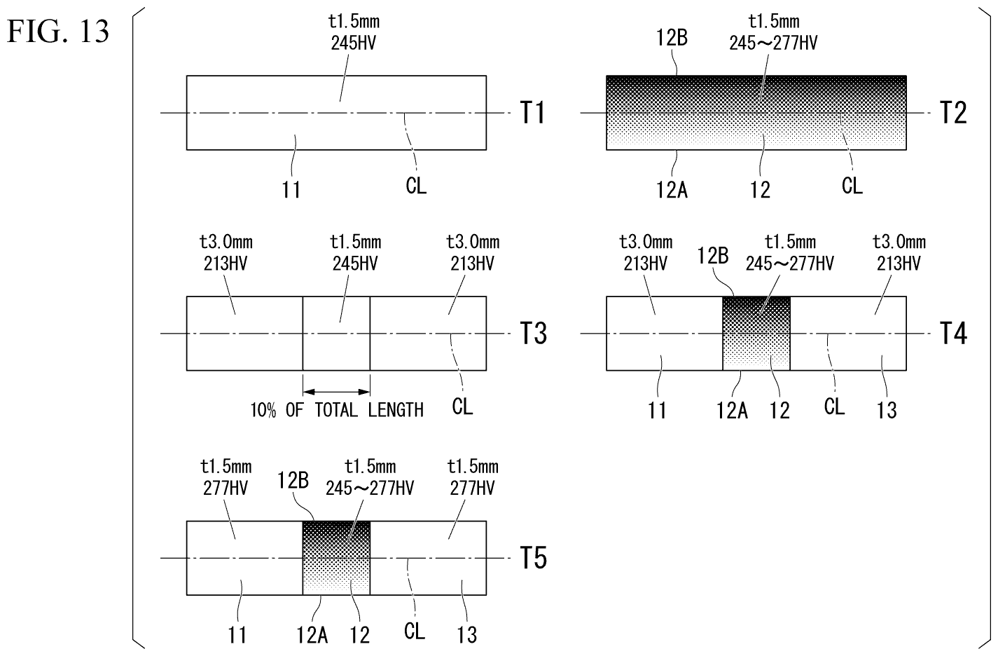

By performing finite element method (FEM) analysis assuming various hollow members, robustness of deformation against a collision condition was evaluated. Specifically, Examples T2, T4, and T5 and Comparative Examples T1 and T3 shown in FIG. 13 were used as evaluation targets.

The steel pipes shown in FIG. 13 are each a circular steel pipe having a central axis CL, and all had the same outer diameter dimension. In Examples T2, T4, and T5 each having a circumferential distribution of Vickers hardness corresponding to the circumferential hardness difference portion 12, the Vickers hardness was set so as to have an absolute minimum value at a measurement position of 0° and so as to have an absolute maximum value at a measurement position of 180°. Note that the height of the Vickers hardness is indicated by shading. On the other hand, in Comparative Examples T1 and T3, the Vickers hardness in the circumferential direction was set to a constant value.

In Example T2, the total length in a longitudinal direction thereof is the circumferential hardness difference portion 12. That is, the Vickers hardness increases or decreases in the circumferential direction within a range of 245 to 277 HV. In addition, a weak portion (low strength range 12A) where the Vickers hardness is an absolute minimum value is set on a lower side of the drawing, and a strong portion (high strength range 12B) where the Vickers hardness is an absolute maximum value is set on an upper side of the drawing. Note that the wall thickness is equally 1.5 mm at each position in the total length and the whole circumference.

Similarly to the hollow member 10 shown in FIG. 1, Example T4 has the first region portion 11, the circumferential hardness difference portion 12, and the second region portion 13 arranged along a longitudinal direction thereof. Each of the first region portion 11 and the second region portion 13 has a Vickers hardness of 213 HV constant along the circumferential direction and a wall thickness of 3.0 mm constant along the circumferential direction. On the other hand, the circumferential hardness difference portion 12 has a Vickers hardness that increases or decreases in the circumferential direction within a range of 245 to 277 HV, and a constant wall thickness of 1.5 mm along the circumferential direction. The circumferential hardness difference portion 12 is formed at a central position in the longitudinal direction, and its length is 10% of the total length of the hollow member 10. In addition, in the circumferential hardness difference portion 12, a weak portion (low strength range 12A) where the Vickers hardness is an absolute minimum value is set on a lower side of the drawing, and a strong portion (high strength range 12B) where the Vickers hardness is an absolute maximum value is set on an upper side of the drawing.

Similarly to the hollow member 10 shown in FIG. 1, Example T5 has the first region portion 11, the circumferential hardness difference portion 12, and the second region portion 13 arranged along a longitudinal direction thereof. Each of the first region portion 11 and the second region portion 13 has a constant Vickers hardness of 277 HV along the circumferential direction and a constant wall thickness of 1.5 mm along the circumferential direction. On the other hand, the circumferential hardness difference portion 12 has a Vickers hardness that increases or decreases in the circumferential direction within a range of 245 to 277 HV, and a constant wall thickness of 1.5 mm along the circumferential direction. The circumferential hardness difference portion 12 is formed at a central position in the longitudinal direction, and its length is 10% of the total length of the hollow member 10. In addition, in the circumferential hardness difference portion 12, a weak portion (low strength range 12A) where the Vickers hardness is an absolute minimum value is set on a lower side of the drawing, and a strong portion (high strength range 12B) where the Vickers hardness is an absolute maximum value is set on an upper side of the drawing.

In Comparative Example T1, the total length in a longitudinal direction thereof is the first region portion 11. That is, the first region portion 11 has a constant Vickers hardness of 245 HV along the circumferential direction and a constant wall thickness of 1.5 mm along the circumferential direction.

Comparative Example T3 has three ranges arranged along a longitudinal direction thereof. That is, each of both end portions has a constant Vickers hardness of 213 HV along the circumferential direction and a constant wall thickness of 3.0 mm along the circumferential direction. On the other hand, a center portion has a constant Vickers hardness of 245 HV along the circumferential direction and a constant wall thickness of 1.5 mm along the circumferential direction. This center portion is formed at a central position in the longitudinal direction, and its length is 10% of the total length of the hollow member 10.

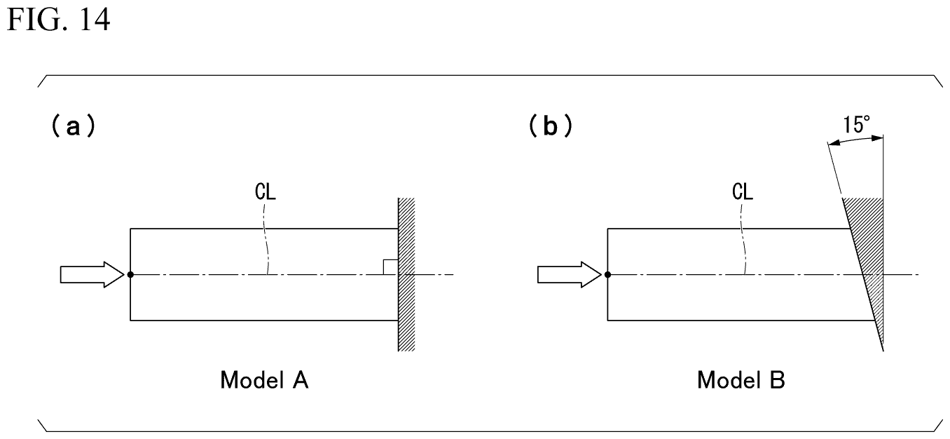

Abaqus/Explicit was used as analysis software, and conditions of Model A and Model B shown in FIGS. 14(a) and 14(b) were set as analysis conditions. Specifically, in Model A, a fixed end having no inclination with respect to a support surface (in which a central axis CL of a hollow member was perpendicular to the support surface) was used. On the other hand, in Model B, a fixed end in which a central axis CL of a hollow member had an inclination of 15° with respect to a support surface was used.

In addition, a case where bending deformation occurred such that a lower side of the drawing was on a recess side and an upper side of the drawing was on a protrusion side was evaluated to be OK. On the other hand, a case where axial collapse occurred or a case where bending in a reaction force direction occurred was evaluated to be NG. Results thereof are presented in Table 1.

TABLE 1

| | | | Comprehensive |
|---|---|---|---|
| | Model A | Model B | evaluation |
| Comparative Example | NG | NG | Unacceptable |
| T1 | | | |
| Example T2 | OK | OK | Acceptable |
| Comparative Example | NG | NG | Unacceptable |
| T3 | | | |
| Example T4 | OK | OK | Acceptable |
| Example T5 | OK | OK | Acceptable |

As shown in Table 1, in Examples T2, T4, and T5 each including the circumferential hardness difference portion 12 having a Vickers hardness distribution, it was confirmed that bending occurred in a weak portion (low strength range 12A) in each of Model A and Model B. That is, it was suggested that robustness of bending deformation against a collision condition was high. On the other hand, in Comparative Examples T1 and T3 having no circumferential hardness difference portion 12, axial collapse or bending in a reaction force direction occurred, and it was suggested that robustness of bending deformation against a collision condition was low.

### Second Example

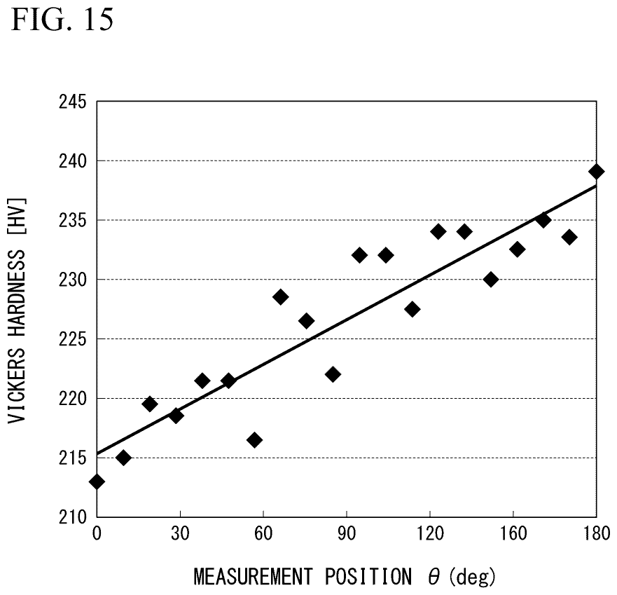

The hollow member 10 was manufactured by the manufacturing method shown in FIG. 7 using the plug 20 having the head portion 20H shown in FIG. 5 and the raw pipe (steel pipe) 30. The Vickers hardness of the circumferential hardness difference portion 12 of the obtained hollow member 10 was measured at a pushing load of 1 kgf and a pitch of 5 mm in the circumferential direction. FIG. 15 shows a result of linear function approximation of the Vickers hardness by a least squares method within a range of θ=0° to θ=180°. As shown in FIG. 15, it was confirmed that the Vickers hardness monotonically increased from θ=0° toward θ=180° although there were some variations. A difference obtained by subtracting HVₘᵢₙ from HVₘₐₓ was about 25 HV or more. Note that a difference obtained by subtracting Tₘᵢₙ from Tₘₐₓ was 0.1 mm or less.

From the above, it has been confirmed by actual measurement that the circumferential hardness difference portion 12 can be formed by the plug 20.

### Third Example

For each of the hollow member 10 in which the circumferential hardness difference portion 12 was formed over the total length in the longitudinal direction and the hollow member 10 in which the circumferential hardness difference portion 12 was formed only at an intermediate position in the longitudinal direction, a difference in Vickers hardness in the circumferential direction necessary for causing bending deformation was obtained by numerical calculation, and comparison was performed.

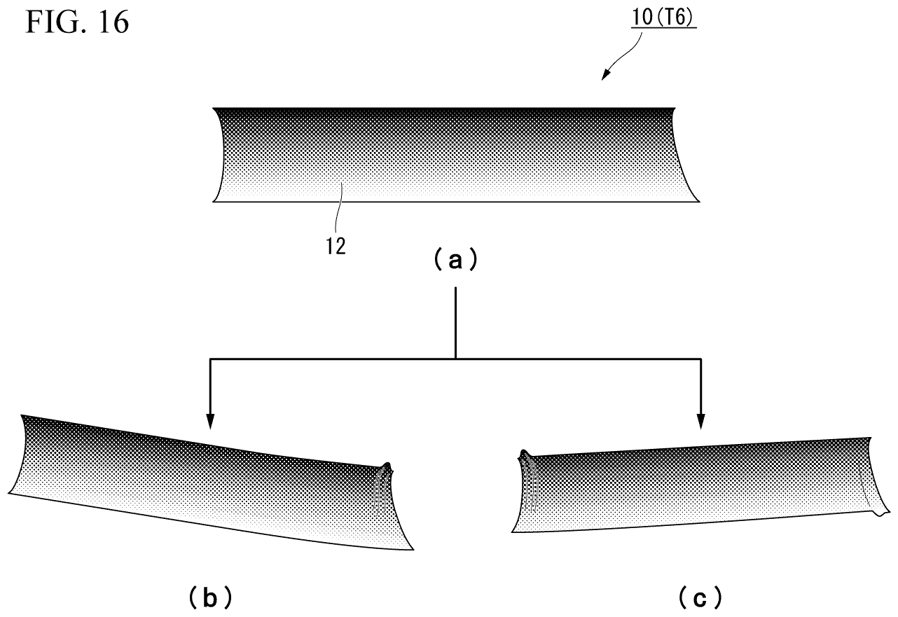

That is, first, Example T6 shown in FIG. 16(a) was prepared as a model of the hollow member 10 in which the circumferential hardness difference portion 12 was formed over the total length in the longitudinal direction. In Example T6, the Vickers hardness of a lower portion of the drawing was set to be the lowest and the Vickers hardness of an upper portion of the drawing was set to be the highest in the total length. Example T6 has the same constitution as the hollow member 10 shown in FIG. 10(a).

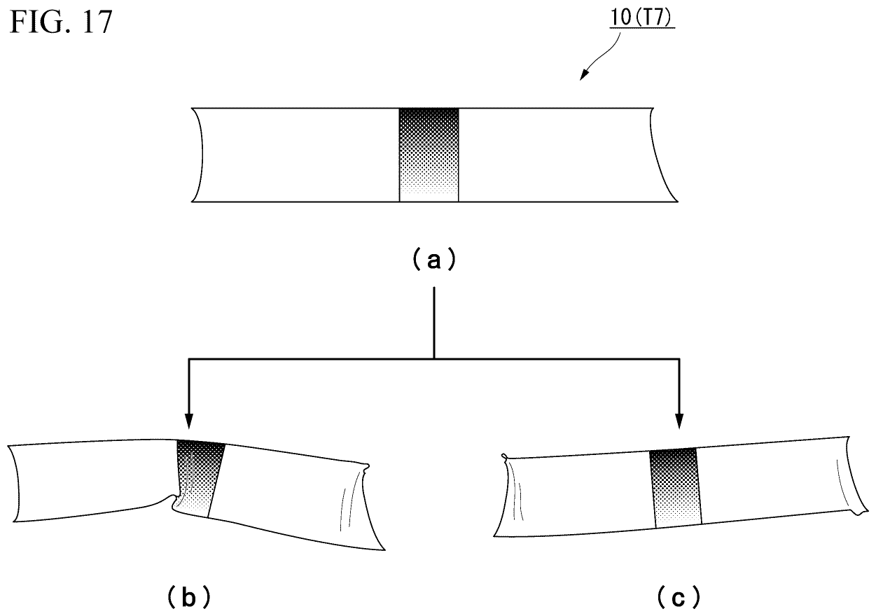

In addition, Example T7 shown in FIG. 17(a) was prepared as a model of the hollow member 10 in which the circumferential hardness difference portion 12 was formed only at a central position in the longitudinal direction. In Example T7, the Vickers hardness of a lower portion of the drawing was set to be the lowest and the Vickers hardness of an upper portion of the drawing was set to be the highest in the circumferential hardness difference portion 12. Example T7 has the same constitution as the hollow member 10 shown in FIG. 1.

A sheet thickness and a dimensional shape in Example T6 were the same as those in Example T7, respectively. On the other hand, a Vickers hardness distribution was calculated by variously changing a difference (circumferential hardness difference) obtained by subtracting an absolute minimum value of the Vickers hardness from an absolute maximum value thereof. Then, on the basis of these calculation results, when the circumferential hardness difference was gradually increased, a boundary value when bending deformation was switched from an unstable state to a stable state was obtained. Note that as analysis software, Abaqus/Explicit was used as in the first Example.

First, in Example T6, the bending deformation was unstable in FIG. 16(c) in which the circumferential hardness difference was 22 HV, but the bending deformation was stable in FIG. 16(b) in which the circumferential hardness difference was 26 HV. Therefore, it was found that 26 HV was required as the circumferential hardness difference in Example T6.

Subsequently, in Example T7, the bending deformation was unstable in FIG. 17(c) in which the circumferential hardness difference was 10 HV, but the bending deformation was stable in FIG. 17(b) in which the circumferential hardness difference was 13 HV. Therefore, it was found that 13 HV was required as the circumferential hardness difference in Example T7.

From the results of Examples T6 and T7, it was confirmed that when the circumferential hardness difference portion 12 is formed only at the central position in the longitudinal direction, stable bending deformation can be obtained with a lower circumferential hardness difference than that obtained when the circumferential hardness difference portion 12 is formed at the total length in the longitudinal direction.

### INDUSTRIAL APPLICABILITY

According to the present disclosure, it is possible to provide a hollow member having enhanced robustness without deteriorating component performance during normal operation, and a hollow member manufacturing method for manufacturing the hollow member. Therefore, industrial applicability is large.

### BRIEF DESCRIPTION OF THE REFERENCE SYMBOLS

10 Hollow member
12 Circumferential hardness difference portion
12A Low strength range
12B High strength range
20 Plug
20a Tapered portion (distal end portion)
20b Parallel portion (main body portion)
30 Raw pipe
40 Die
CL Central axis
HVₐᵥ Hardness threshold
Lr Whole outer circumferential length
Pₘᵢₙ Hardness minimum position
Pₘₐₓ Hardness maximum position
p1 First connection point
p2 Second connection point
VS Virtual surface (surface orthogonal to central axis of plug)

1. A hollow member having a circumferential hardness difference portion in at least a portion in a longitudinal direction along a central axis, wherein
when the circumferential hardness difference portion is viewed in a cross section orthogonal to the central axis,
a wall thickness difference obtained by subtracting an absolute minimum value of the wall thickness from an absolute maximum value of the wall thickness in a circumferential direction of the cross section is 20% or less of an average value of the wall thickness in a whole circumference of the cross section, and
when an average of integration of Vickers hardness in the whole circumference of the cross section is used as a hardness threshold, the cross section includes a low strength range in which the Vickers hardness along the circumferential direction is equal to or less than the hardness threshold and a high strength range in which the Vickers hardness along the circumferential direction is more than the hardness threshold.

2. The hollow member according to claim 1, wherein
a ratio of a circumferential length of the low strength range to a whole outer circumferential length of the cross section is within a range of 20% to 80%.

3. The hollow member according to claim 1, wherein
a whole outer circumferential length in the cross section is Lr (mm), and
a hardness maximum position at which the Vickers hardness is an absolute maximum value is within a range of 0.3×Lr (mm) to 0.7×Lr (mm) in the circumferential direction with a hardness minimum position at which the Vickers hardness is an absolute minimum value as a reference.

4. The hollow member according to claim 1, wherein
the wall thickness difference in the cross section is 0.10 mm or less, and
a difference obtained by subtracting an absolute minimum value of the Vickers hardness from an absolute maximum value of the Vickers hardness in the cross section is 15 HV or more.

5. The hollow member according to claim 1, wherein the circumferential hardness difference portion is formed only in a part of the longitudinal direction.

6. The hollow member according to claim 1, wherein the circumferential hardness difference portion is formed over a total length in the longitudinal direction.

7. A hollow member manufacturing method for manufacturing a hollow member from a hollow cylindrical raw pipe, the method comprising:
a raw pipe disposition step of disposing the raw pipe in a die; and
an ironing step of ironing a material of an inner wall of the raw pipe so as to feed out the material in a circumferential direction of the inner wall when viewed from a line of sight along a central axis of the raw pipe while enlarging the inner wall by pushing a plug into the raw pipe.

8. The hollow member manufacturing method according to claim 7, wherein
the plug has a distal end portion tapered in a push-in direction and a main body portion continuous with a rear end of the distal end portion and having a maximum outer shape dimension in a cross section perpendicular to the push-in direction, and
a surface including a connection line between the distal end portion and the main body portion is inclined with respect to a surface orthogonal to a central axis of the plug.

9. The hollow member manufacturing method according to claim 7, wherein
the plug has a distal end portion tapered in a push-in direction and a main body portion continuous with a rear end of the distal end portion and having a maximum outer shape dimension in a cross section perpendicular to the push-in direction, and
a connection line between the distal end portion and the main body portion includes:
a plurality of first connection points closest to a distal end surface of the plug in a side view; and
a plurality of second connection points located between the first connection points in a front view and located farther from the distal end surface than the first connection points in a side view.

10. The hollow member manufacturing method according to claim 7, further comprising:
a locking step of locking an enlarged portion where an outer shape of an end portion of the raw pipe is enlarged in the die, by pushing the plug into the end portion after the raw pipe disposition step and before the ironing step; and
a drawing step of causing the enlarged portion to pass through another die to reduce the enlarged portion after the ironing step.

11. The hollow member manufacturing method according to claim 10, further comprising, after the drawing step, a press working step of performing press forming such that a cross-sectional shape perpendicular to the central axis is rectangular.

12. The hollow member manufacturing method according to claim 7, further comprising, after the drawing step, a press working step of performing press forming such that a cross-sectional shape perpendicular to the central axis is rectangular.
